(19) United States
(12) Patent Application Publication
(10) Pub. No.: US 2003/0030335 A1
(43) Pub. Date: Feb. 13, 2003

(54) HYDRODYNAMIC SPINDLE MOTOR USING WELDING SEALING TECHNIQUE

(76) Inventors: Dirk A. Krieger, Woodside, CA (US); Klaus Kloppel, Watsonville, CA (US); Etoli Wolff, Sunnyvale, CA (US); Steven N. Parsoneault, Scotts Valley, CA (US); Don J. Macleod, Santa Cruz, CA (US)

Correspondence Address: Flehr Hohbach Test, Albritton & Herbert LLP, Suite 3400 Four Embrcadero Center, San Francisco, CA, 94111, US

(21) Appl. No.: 09/489,293

(22) Filed: Jan. 21, 2000

Related U.S. Application Data
(60) Provisional application No. 60/116,756, filed on Jan. 22, 1999.

(51) Int. Cl. H02K 7/00

(52) U.S. Cl. 310/67 R

(57) ABSTRACT

A cartridge or motor which includes a shaft with a thrust plate at one end; the counterplate which lies across the end of the shaft is welded to an extension of the sleeve in which the counterplate is fit.

### CROSS-REFERENCE TO A RELATED APPLICATION

This application claims priority to provisional application Serial No. 60/116,756 filed Jan. 22, 1999 and assigned to the assignee of this application; the priority of this provisional application is hereby claimed.

### FIELD OF THE INVENTION

The present invention relates to hydrodynamic bearing motors and more specifically to method and structure for successfully sealing such a motor.

### BACKGROUND OF THE INVENTION

Magnetic disc drives are used for magnetically storing information. In a magnetic disc drive, a magnetic disc rotates at high speed and a transducing head flies over the surface of the disc. This transducing head records information on the disc surface by impressing a magnetic field on the disc. Information is read back using the head by detecting magnetization of the disc surface. The transducing head is moved radially across the surface of the disc so that different grades of tracks can be read back.

Over the years, storage density has increased and the size of the storage system has decreased. This trend has lead to greater precision and lower tolerance in the manufacturing and operating of magnetic storage discs. For example, to achieve increased storage densities, the transducing head must be placed increasingly close to the surface of the disc. This proximity requires that the disc rotate substantially on a single plane. A slight wobble or run out in disc rotation can cause the surface of the disc to contact the transducing head. This is known as a crash and can damage the transducing head surface of the storage disc, resulting in loss of data.

From the foregoing discussion, it can be seen that the varying assembly which supports the disc is of critical importance. For this reason, substantial research work has been done on the development of hydrodynamic bearings. In such a bearing, a lubricating fluid, such as air liquid, provides a bearing surface between a fixed member of the housing and a rotating member of the disc hub. Hydrodynamic bearings spread the bearing interface over a large surface area in comparison with the ball bearing assembly, reducing wobble or run out between the rotating and fixed members. Further, shock resistance and ruggedness is improved. Further, the use of fluid in the interface area imparts damping effects to the bearing which helps to reduce nonrepeat run out. However, the bearings themselves, because of the inclusion of the fluids, must be sealed so that the fluid cannot leak or disburse into the atmosphere surrounding the bearing and motor. Such leakage can contaminate either the disc or the transducer, dramatically reducing the life of the disc drive.

Currently assembly processes in sealing the end of the motor where the shaft terminates, typically supporting a thrust plate, will require the use of a absorbent compressible o-ring inserted in a groove which must be machined in the sleeves surrounding the shaft. A counterplate and washer or similar are required to hold the o-ring in place.

However, there are several potential downfalls of the o-ring method. Because some fluid leakage is possible between the end of the sleeve and the counterplate which rests against the sleeve and presses the o-ring in place, the o-ring can saturate, allowing some future loss of fluid beyond this saturation point. Further, there can be some loss by evaporation from the saturated o-ring. Finally, the o-ring demands extra lateral spacing in the hub, as well as machining of a o-ring groove, together with the cost of the o-ring itself.

Therefore, a better sealing technique is needed.

### SUMMARY OF THE INVENTION

The present invention is intended to overcome many of the deficiencies inherent in the prior art. More specifically, the present invention, which comprises a shaft with a thrust plate at one end, directly welds the counterplate which lies across the end of the shaft to an extension of the sleeve in which the counterplate is fit. In this way, the o-ring, and the sealing washer, which had to be incorporated into the prior art, are both deleted. This results in a more robust, less expensive and higher quality motor.

### BRIEF DESCRIPTION OF THE DRAWINGS

FIG. 1 is a sectional view which illustrates in part the prior art design, and illustrates in further part an example of the new invention.

FIG. 2 is a vertical sectional view of a typical spindle motor for a disc drive incorporating the present invention.

### DETAILED DESCRIPTION OF A PREFERRED EMBODIMENT

The present invention is intended to more efficiently and economically seal a hydrodynamic bearing incorporated within a spindle motor such as is used in a disc drive or the like, where contaminants or gases generated within the bearing must be prevented from exiting the bearing gap region.

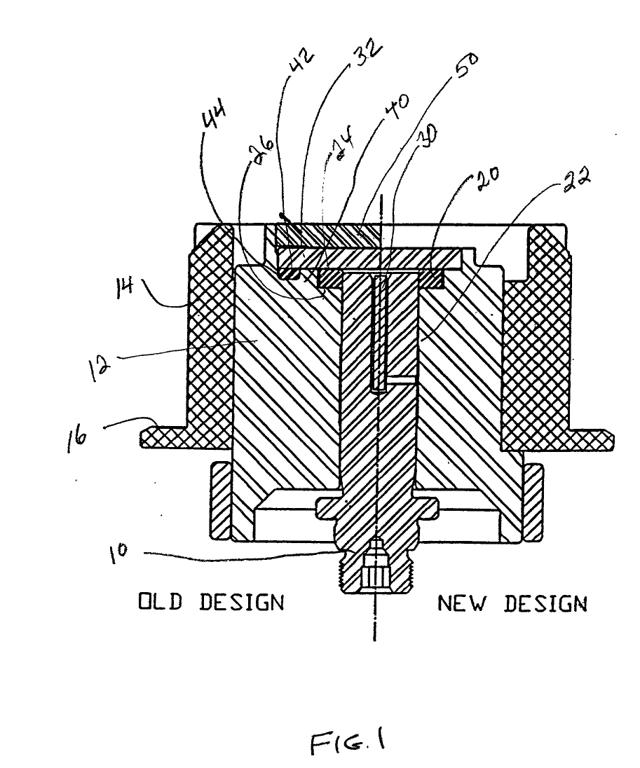

Referring to FIG. 1, especially the left-hand side thereof, the basic elements of a typical spindle motor include a fixed shaft 10 which supports for rotation a sleeve 12 having a hub or the like 14 which has a flange 16 capable of supporting one or more disc for rotation thereon. A thrust plate 20 is supported at one end of the shaft, with the hydrodynamic bearing or bearings 22 extending both axially along the surface of the shaft and radially along both surfaces 24, 26 of the thrust plate to enhance the radial and axial stability of the system. The fluid (not shown) of the system is maintained in the reservoir 30 inside the central shaft 10, and circulates over the surfaces and through the gap between the shaft 22 and the sleeve 12 as well as the thrust plate surface 26 and the sleeve 12 and the thrust plate surface 24 and the counterplate 32. In order to prevent any loss of fluid from the gap, it must not be allowed to escape between the upright portion 40 of the sleeve and the facing surface of the counterplate 32. For this reason, the prior art has proposed and utilized a o-ring 42 which rests in a groove 44 in the surface of the sleeve facing the counterplate 32. However, this approach requires both the expense of forming the groove 44 in the sleeve, as well as the cost of the o-ring 42 and the equipment time to insert the o-ring 42 in the groove. Further, in order to maintain the compression of the o-ring and diminish the possibility of fluid escaping, in addition to the counterplate facing the o-ring, a further washer 50 must be used and held in place against the counterplate.

An additional difficulty is that some additional lateral or radial width in the sleeve 12 is required in order to accommodate the o-ring 42 radially spaced from the thrust plate 24.

To eliminate this possibility, it has been proposed as shown schematically on the right side of FIG. 1, that the o-ring 42 and its groove 44 be replaced or eliminated, as well as the washer 50. It can immediately be seen from a comparison of the left and right sides of FIG. 1, that this diminishes the radial spacing of the sleeve 12, as well as eliminating the need for a machining step to create the groove, and reducing the part count by eliminating both the o-ring 42 and the washer 50.

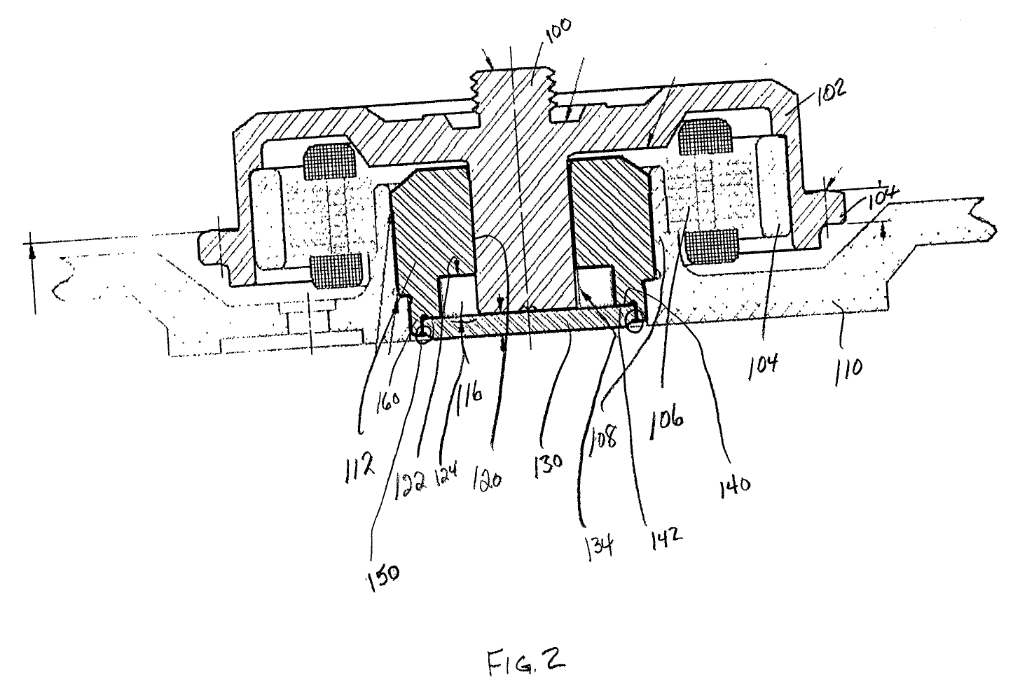

Details of implementing this approach are found in FIG. 2.

FIG. 2 shows a design which in contrast to FIG. 1 is a rotating shaft 100 as the shaft is integrated with the hub 102 which carries flange 104 which functions as a disc support surface. The shaft with the hub 102 supports a magnet 104 on its inner axial surface, facing stator 106 whose energization causes stable rotation of the hub. The stator in turn is supported on a axial extension 108 of base casting 110. A sleeve 112 which supports the shaft 100 and its associated thrust plate 116 is incorporated into the axial extension 108 of the base 110. This sleeve 112 has axial surface 120 that faces a surface of the shaft. These two surfaces define a journal bearing which is of standard design and not further shown. Further, the thrust plate at surfaces 122 and 124 define in cooperation with the sleeve 112 and the counterplate 130 thrust bearings of the fluid dynamic type which further support the shaft against both axial and radial forces. Each of these journals and thrust bearings require fluid in the gap between the facing surfaces. This fluid may either recirculate through an internal channel 134 which either passes through the thrust plate or between the thrust plate and shaft, or return through a central reservoir or the like such as the reservoir 30 shown in FIG. 1. In either case, a primary cause for concern is with the old design of FIG. 1 is to prevent the escape of any fluid between the surface 140 of the sleeve and the complementary surface 142 of the thrust plate. To avoid this loss, while enhancing the simplicity of the design, a laser weld has been applied at the junction at the axially outer edge of the thrust plate 130 and the sleeve 112. This laser weld is applied using well-known techniques and technology but by its very simplicity enhances the reliability.

This simple appearing change provides a better sealing technique and a more robust, less expensive and higher quality motor. It eliminates the need for the O-ring 42 and the O-ring groove 44 which appear in FIG. 1, as well as the center washer 50 which is integral to maintaining the counterplates sealed tightly against the washer. It eliminates the radial space requirement for the O-ring, and even simplifies the dimension of the counterplate relative to the axial arm 160 of the sleeve 112. It also provides for easier oil filling.

This invention eliminates the axial play which relates to pinched O-rings, and diminishes the possibility of O-ring oil absorption and O-ring leakage.

Other features and advantages of this invention will be apparent to a person of skill in the art who studies this invention disclosure. Therefore, the scope of the invention is to be limited only by the following claims.

What is claimed is:

1. A spindle motor for use in a disc drive comprising
a shaft supporting a thrust plate at one end thereof,
a sleeve surrounding the shaft and adjacent the thrust plate and cooperating with the shaft to define a journal bearing and the thrust plate to define a first fluid thrust bearing,
a counterplate welded to upraised axial arms of said sleeve and located adjacent said thrust plate to define a second fluid dynamic thrust bearing,
the welded counterplate containing fluid within the thrust bearings and the journal bearing.

2. A spindle motor as claimed in claim 1 wherein the shaft is fixed and the sleeve and counterplate rotate relative to the shaft.

3. A spindle motor as claimed in claim 2 wherein the sleeve supports a hub for supporting a disc for rotation about the shaft.

4. A spindle motor as claimed in claim 1 wherein the shaft is free to rotate relative to the sleeve and counterplate.

5. A spindle motor as claimed in claim 4 wherein the sleeve and counterplate are fixed to a base which supports the motor.

6. A spindle motor as claimed in claim 5 wherein the shaft supports a hub for rotation over said base.

7. A spindle motor as claimed in claim 6 wherein the hub supports one or more discs for rotation.

8. A spindle motor for use in a disc drive comprising
a shaft supporting a thrust plate at one end thereof,
a sleeve surrounding the shaft and adjacent the thrust plate and cooperating with the shaft to define a journal bearing and the thrust plate to define a first fluid thrust bearing,
a counterplate supported between upraised axial arms of said sleeve and located adjacent said thrust plate to define a second fluid dynamic thrust bearing,
means for containing fluid within the thrust bearings and the journal bearing.
